(19) United States
(12) Patent Application Publication
(10) Pub. No.: US 2007/0252959 A1
(43) Pub. Date: Nov. 1, 2007

(54) Device for Controlling the Temperature of Elements

(76) Inventors: Tilmann Schwertner, Aalen (DE); Ulrich Bingel, Lauterburg (DE); Klaus Zimmer, Kernen (DE)

Correspondence Address: GRAY ROBINSON, P.A., P.O. Box 2328, FT. LAUDERDALE, FL, 33303-9998, US

(21) Appl. No.: 11/576,349

(22) PCT Filed: Sep. 24, 2005
(86) PCT No.: PCT/EP05/10351

§ 371 Date: Mar. 30, 2007

(30) Foreign Application Priority Data
Sep. 30, 2004 (DE) 10 2004 047 533.4

(51) Int. Cl. G03B 27/42; G03B 27/52

(52) U.S. Cl. 355/30; 355/77

(57) ABSTRACT

The invention relates to a device for adjusting the temperature of elements, especially adjusting the temperature of a projection lens (1) or of parts of a projection lens (1) for use in semiconductor lithography. Said device comprises a temperature-adjusting jacket (18) which is provided with at least one temperature-adjusting line (19). Said at least one temperature-adjusting line (19) is formed into the temperature-adjusting jacket (18).

### BACKGROUND OF THE INVENTION

1. Field of the Invention

The invention relates to a device for controlling the temperature of elements, in particular for controlling the temperature of a projection objective or of parts of a projection objective in semiconductor lithography, having a temperature control jacket that is provided with at least one temperature control line. The invention further relates to a method for producing a device for controlling the temperature of elements of a projection objective or parts of a projection objective in semiconductor lithography, the temperature control jacket with at least one temperature control line being used for controlling the temperature. The invention also relates to the use of a device for controlling the temperature in a EUV projection exposure machine.

2. Description of the Related Art

Projection objectives or parts of projection objectives in semiconductor lithography are frequently surrounded by cooling jackets in order to maintain a constant temperature for a high positional accuracy. Devices for cooling a projection objective are known, for example, from U.S. Pat. No. 5,812,242, from U.S. Pat. No. 6,153,877 and from US 2002/0027645 A1.

Disadvantages of the prior art set forth above reside in a poor heat transfer between the cooling jacket and the cooling lines or cooling tubes, since the heat transfer surface is very small where the cooling lines are applied to the cooling jacket for example by bonding. Furthermore, the bonding of the cooling lines to the cooling jacket is attended by the risk of the adhesive used causing contamination by degassing. Again, the strength of the adhesive used is frequently not sufficient, and thus there is a need for additional connecting elements for fastening the cooling lines on the cooling jackets. It is, furthermore, disadvantageous that a large design space is required when use is made of round line cross sections for the cooling lines, it being possible however, for angular or oval line cross sections to be deformed or bent only with great difficulty. It is also very complicated to adapt the cooling lines to cooling jackets that are not of flat design, for example of round design.

### SUMMARY OF THE INVENTION

It is therefore the object of the present invention to provide a device for controlling the temperature of elements, in particular for controlling the temperature of a projection objective or of parts of a projection objective, with high accuracy and effectiveness and without a high structure outlay.

According to the invention, this object is achieved by virtue of the fact that the at least one temperature control line is integrally formed in the temperature control jacket.

Owing to the inventive integral formation of the temperature control line in the temperature control jacket, a good heat transfer is ensured between the temperature control jacket and the temperature control lines, since a temperature control means that is being used is in direct and/or full contact with the temperature control jacket. The configuration of the temperature control line, as also the distribution of the latter on the temperature control jacket, is simpler according to the invention and owing to the integral formation, and is possible without a separate high design outlay for a separate temperature control line. The temperature gradient can be set more freely in this way, since there is no need to adapt temperature control lines to the temperature control jacket. A further advantage of the device according to the invention is that after the integral formation of the temperature control line the temperature control jacket can be deformed as a whole depending on the configuration of the projection objective or parts of the projection objective. This avoids a complicated and difficult deformation or bending of the temperature control jacket with separate temperature control lines in order to adapt to the projection objective, as is the case in the prior art.

In an advantageous refinement of the invention, it can be provided that the temperature control jacket is of bipartite design, the temperature control line being integrally formed in at least one subelement, and the subelements being interconnected via an adhesive. Accordingly, the connection of two subelements that form the temperature control jacket enables the use of an adhesive for bonding over a large surface without loss of strength. Since only end faces of the temperature control jacket respectively come into contact with the surroundings and/or the ambient air, degassing of the adhesive surface between the two subelements of the temperature control jacket is only minimal, and so less contamination occurs for the projection exposure machine.

The present object is achieved, furthermore, by virtue of the fact that the at least one temperature control line is integrally formed on the temperature control jacket via an electroplating process.

Consequently, according to the invention there is a further possibility for producing the temperature control jacket. It is also possible to produce temperature control jackets with complex geometries by means of the inventive electroplating process, in particular an electroforming.

Advantageous refinements and developments of the invention follow from the remaining subclaims. Exemplary embodiment of the invention are explained in more detail below with the aid of the drawings.

### BRIEF DESCRIPTION OF THE DRAWINGS

FIG. 1 shows a schematic with the mode of operation of a projection objective for microlithography, the projection objective having temperature control jackets;

FIG. 2 shows a schematic of a temperature control jacket with an inserted temperature control line;

FIG. 3 shows an enlarged view according to the line III-III of the temperature control jacket illustrated in FIG. 2;

FIG. 4 shows an alternative design of temperature control jacket of the view, illustrated in FIG. 3, according to the line III-III in accordance with FIG. 2;

FIG. 5 shows a schematic of an alternative temperature control jacket with temperature control lines, connected to a projection objective;

FIGS. 6a to 6c show schematics of inventive method steps for producing a temperature control jacket with temperature control lines in accordance with FIG. 5 by means of an electroplating process; and

FIG. 7 shows a schematic design of an EUV projection exposure machine with a light source, an illumination system and projection objective.

### DETAILED DESCRIPTION

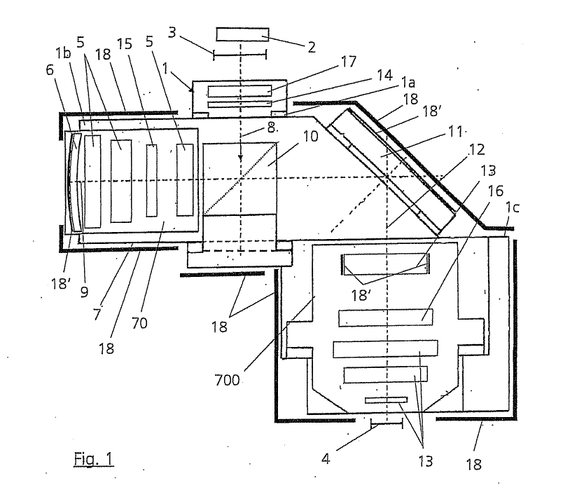

FIG. 1 illustrates schematically a projection exposure machine with a projection objective 1 for microlithography for the purpose of producing semiconductor components.

The projection exposure machine has an illumination system 2 with a laser (not illustrated) as light source. Located in an objective plane of the projection exposure machine is a reticle 3 whose structure is to be imaged on an appropriately reduced scale on a wafer 4 that is arranged beneath the projection objective 1 and is located in an image plane.

The projection objective 1 has a first vertical objective part 1 a and a second horizontal objective part 1b. Provided in the objective part 1b are a number of lenses 5 and a concave mirror 6, which together form a subassembly 70 and are arranged in an objective housing 7 of the objective part 1b. Provided for the purpose of deflecting a projection beam, marked here only by an arrow, from the vertical objective part 1a with a vertical optical axis 8 into the horizontal objective part 1b with the horizontal optical axis 9 is a beam splitter element 10 that is designed here as a beam splitter cube. After being reflected at the concave mirror 6 and subsequently passing through the beam splitter element 10, the projection beam strikes a deflection mirror 11. The horizontal beam path is deflected at the deflecting mirror 11 along the optical axis 9 into a vertical optical axis 12, in turn. Provided underneath the deflecting mirror 11 is a third vertical objective part 1c with a further lens group 13. In addition, three λ/4 plates 14, 15 and 16 are also located in the beam path. The λ/4 plate 14 is located in the projection objective 1 between the reticle 3 and the beam splitter element 10 downstream of a lens or lens group 17. The λ/4 plate 15 is located in the beam path of the horizontal objective part 1b, and the λ/4 plate 16, which forms an optical subassembly 700 with the lens group 13, is located in the third objective part 1c. The three λ/4 plates 14, 15, 16 server the purpose of completely rotating the polarization once, as a result of which, inter alia, beam losses are minimized.

Temperature control jackets 18 are also illustrated in FIG. 1. These serve to cool the elements. In this exemplary embodiment, the projection objective 1 is provided with a number of temperature control jackets 18, the intention being to control the temperature of the projection objective 1 (the entire surface as far as possible). In order to keep the optical subassemblies 10, 11, 70 and 700 thermally stable, the temperature control jackets 18 are used to keep stress from the surroundings away from the subassemblies. In order to avoid heating of the projection objective 1 from inside, for example through absorption of the optical elements 5, 6, 10, 13, 15 and 16, it is possible in addition further to provide inner temperature control jackets (18′) for the individual elements. Regions particularly sensitive in thermal terms such as, for example the mirror 6 or the deflecting mirror 11, of the projection objective 1 can also be provided in a mechanically and thermally separate fashion with temperature control jackets 18′ and with a dedicated temperature control circuit. The fastening of the temperature control jackets 18 on the projection objective 1, as also on individual parts and elements of the projection objective 1, can be performed in the customary way known.

The design and the production of a temperature control jacket 18 is described in more detail in the following exemplary embodiments.

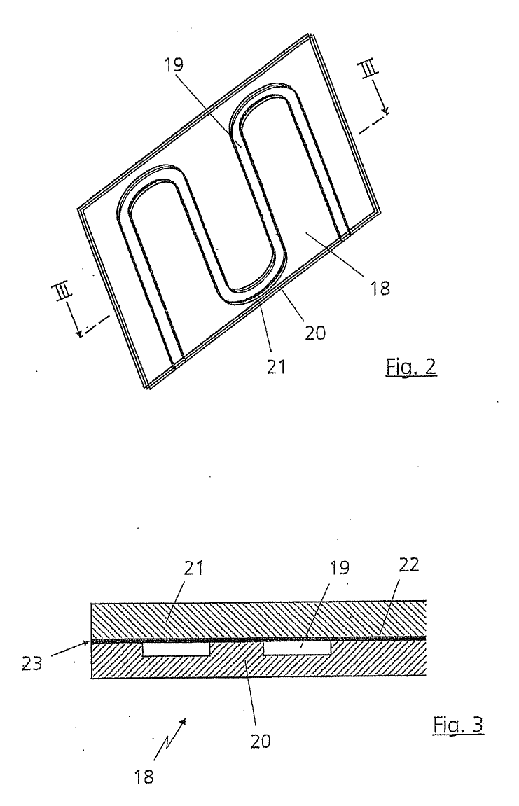

A view of a temperature control jacket 18 is illustrated schematically in FIG. 2. Integrally formed in the temperature control jacket 18 is a temperature control line 19 that has a temperature control means (a gas or a liquid) for controlling the temperature of, in the present case for cooling, the projection objective 1. The temperature control jacket 18 is of bipartite design, that is to say the temperature control jacket 18 has a first subelement 20 and a second subelement 21. In at least one of the two subelements 20 and/or 21, cutouts for forming the temperature control line 19 are introduced via a cutting off process, for example by means of a milling operation. The subelements 20, 21 shown in this exemplary embodiment are illustrated transparently for the purpose of more easily detecting the temperature control line 19.

FIG. 3 illustrates schematically a longitudinal section, according to the line III-III in accordance with FIG. 2, through the temperature control jacket 18, the temperature control line 19 being inserted only into the subelement 20. It goes without saying that it is also possible to insert the temperature control line 19 only into the subelement 21 or else into both subelements 20 and 21. The two subelements 20 and 21 are interconnected in such a way that an at least approximately full surface contact is present between the subelements 20 and 21. This can be performed, for example, by bonding the subelements 20, 21 by means of an adhesive 22. A large area bonding of this kind ensures high strength between the subelements 20 and 21. In this case, bonding surfaces of the two subelements 20 and 21 connect to the surroundings or to the ambient air only at end faces 23, the advantage thereby resulting that less adhesive surface can degas and lead to contamination. One advantage of the at least approximately full surface contact between the subelements 20 and 21 is, however, the very good heat transfer.

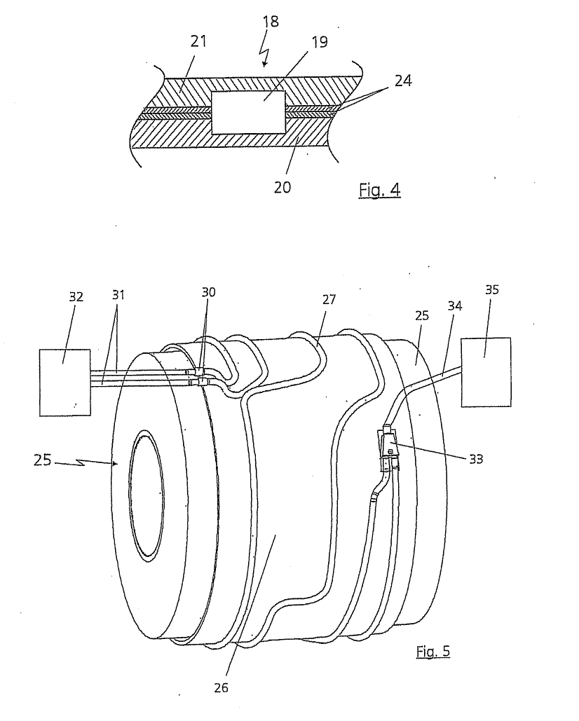

An alternative possibility for connecting subelements 20, 21 is illustrated in FIG. 4. In this exemplary embodiment, the temperature control line 19 is formed by cutouts in the two subelements 20, 21 of the temperature control jacket 18. Instead of the two subelements 20, 21 being bonded to one another, the two subelements 20, 21 are connected here via an alternative connecting operation, for example soldering. In this case, solders 24 are rolled onto each of the subelements 20 and 21 without supplying heat, that is to say in cold state. Hereafter, the two subelements 20 and 21 are joined to one another and interconnected by heating, as a result of which the two solders 24 fuse with the subelements 20 and 21. Aluminum is preferred as material for the two subelements 20, 21 for reasons of good thermal conductivity. Aluminum can also be suitably soldered in a vacuum without flux. There is likewise in this way an at least approximately full surface connection of high strength between the two subelements 20 and 21. Of course, other materials can also be used in case of need for the subelements 20 and 21.

One advantage of the method according to FIG. 3 and FIG. 4 is that after introduction of the temperature control lines 19 the temperature control jacket 18 can be deformed as an overall element depending on the design of the object or element whose temperature is to be controlled. A further advantage of the temperature control jacket 18 thus produced resides in a very good heat transfer, since the temperature control means is in direct or full contact with the temperature control jacket 18. The configuration of the temperature control line 19, and also the distribution thereof on the temperature control jacket 18 can be multifarious or be multifariously fashioned, since the temperature control line 19 need neither be applied nor adapted to the temperature control jacket 18 in a separate production or operating cycle.

However, there is advantage in round temperature control lines that have a uniform cross section and no narrow radii or kinks, the result being the occurrence of less noise from the flow of temperature control means, and thus no transfer of vibrations to the optics. Furthermore, the aim should be as uniform as possible a distribution of the temperature control line or the temperature control lines over the surface of the jacket, so that a uniform temperature distribution is present over the surface of the jacket. In the event of flat surfaces or two-dimensional optics, temperature control lines can be introduced in coiled fashion in the temperature control jacket. In the case of round optics such as for example, the projection objective 1, it is most advantageous to have a spiral arrangement of one or more temperature control lines in order to achieve a uniform temperature distribution.

FIG. 5 shows a projection objective 25 that is surrounded by a temperature control jacket 26. The temperature control jacket 26 can in this case be fitted on the outside of the projection objective 25 in a known way. In this alternative exemplary embodiment, temperature control lines 27 are integrally formed on the temperature control jacket 26. The integral formation of the temperature control lines 27 is performed via an electroplating process, in particular an electroforming. In FIG. 5, the temperature control lines have connections 30 that are coupled to lines 31 that are, in turn, connected to a unit 32 for supplying and controlling the temperature control means. Furthermore, the temperature control lines 27 lead to a distribution connection 33 that is connected to a line 34 for transporting the temperature control means away to a discharge and control unit 35.

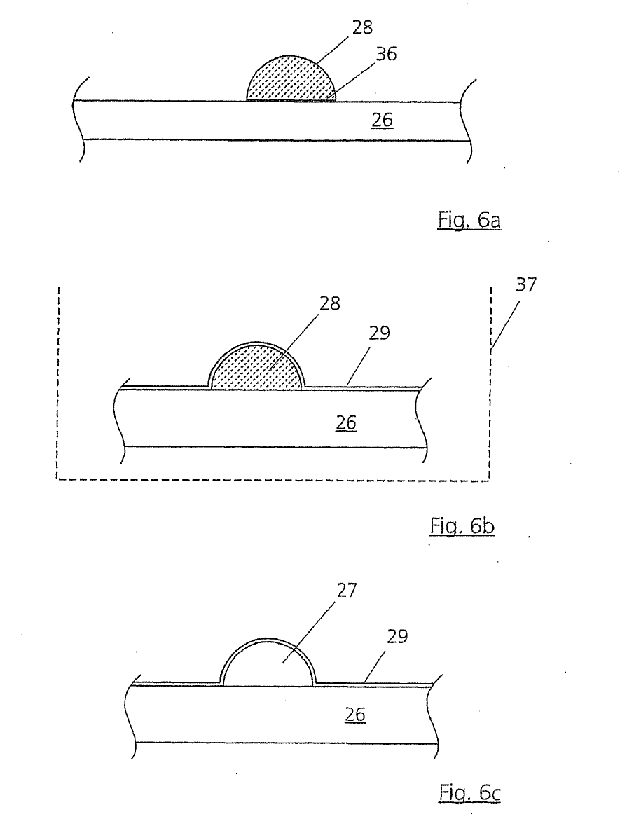

The process of electroforming for forming or producing a temperature control line 27 on the temperature control jacket 26 is to be explained in more detail below with the aid of FIGS. 6a, 6b and 6c.

In accordance with FIG. 6a, in order to produce the temperature control line 27 on the temperature control jacket 26 a molding compound 28 is applied to the temperature control jacket 26 in such a way that the molding compound 28 forms an inner cross section of the temperature control line 27. By way of example, wax filled with graphite, metallically filled plastics or another electrically conducting material that can be processed very effectively can be used as molding compound 28. By way of example, the molding compound 28 can be applied to the temperature control jacket 26 by means of thermally unstable adhesive 36, and be modeled depending on the configuration of the cross section and the provided course of the temperature control line 27. Self-adhesive molding compounds can also be used.

In accordance with FIG. 6b, the temperature control jacket 26 is introduced with the molding compound 28, which is electrically conducting, into a plating tank, illustrated by dashes with the designation 37. In this case, the objects to be coated with a metal layer, here the temperature control jacket 26 and the molding compound 28, are connected as cathode. The metal ions of a metal salt solution that is being used are then discharged at the temperature control jacket 26 and the molding compound 28 as cathode, and are deposited as layer. The deposition conditions such as the composition of the electrolyte, cathodic current density, electrolyte temperature and electrolytic circulation as well as electrodeposition periods are selected in such a way that the deposited metal coating has a property profile correct for the application. In this way, the molding compound 28 and also the temperature control jacket 26 are covered with an electrodeposited layer 29. The electrodeposited layer 29 can be formed, for example, of nickel, it also being possible, of course, to use other metals such as, for example, copper, tin, aluminum or combinations of a number of metals for the purpose of forming the electrodeposited layer 29.

After the desired layer thickness of the electrodeposited layer 29 has been reached on the temperature control jacket 26 and/or on the molding compound 28, the temperature control jacket 26 is withdrawn from the plating tank. The molding compound 28 is removed in order to form the temperature control line 27, thus resulting in a cutout. The removal of the molding compound 28 can be performed, for example, by heating, when a wax, for example, is used as molding compound 28, by washing out when the molding compound 28 is water-soluble, or else by etching.

FIG. 6c shows the temperature control jacket 26 with a temperature control line 27 formed in this way, through which the temperature control means can flow for the purpose of cooling the projection objective 26 according to FIG. 5 or for cooling parts of the projection objective 1 in semiconductor lithography.

Temperature control jackets with complex geometries can also be produced by means of this electroplating process, since only the molding compound 28 to be processed need be processed in order to form a temperature control line 27 and the processing can be performed very simply.

The temperature control jackets 18, 18′ and 26 can be used with increased heat generation in order to cool or else to heat a projection objective, individual optical elements or else mechanical elements.

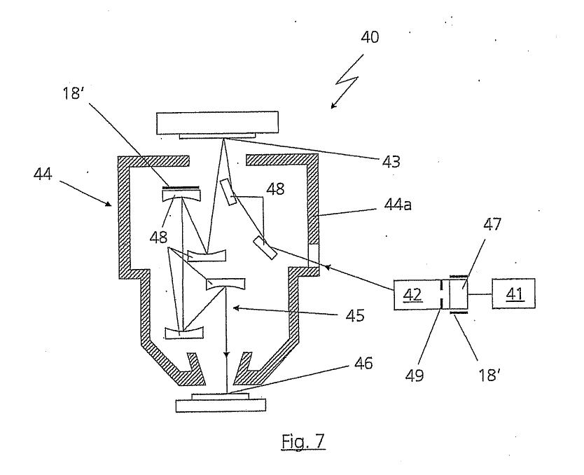

FIG. 7 illustrates an EUV projection exposure machine 40 with a light source 41, an EUV illumination system 42 for illuminating a field in an object plane 43, in which a structure bearing mask is arranged, as well as a projection objective 44 with a housing 44a and a beam path 45, provided by a number of deflecting mirrors 48, for imaging the structure bearing mask in the object plane 43 onto a photosensitive substrate 46 for producing semiconductor components. The EUV illumination system 42 advantageously has a collector unit 47 on the side directed toward the light source 41, in order to focus the radiation generated by the light source 41.

In the case of the EUV projection exposure machine 40 as well, parts of the objective housing 44a, or the entire housing can, just like the optical elements in the interior of the projection objective 44, be provided with a temperature control jacket 18 or 18′. The same holds for the collector unit 47 that is provided for collecting the radiation output by the light source 41.

Such collector units are used for an illumination system at wavelengths of ≦193 nm, and are generally known in principle. Reference is made by way of example to this end to DE 102 14 259 A1 and the older U.S. provisional application Ser. No. 60/695,932, whose contents are to be reckoned in the disclosure content of the present application.

In addition to cooling the optical elements such as, for example, lenses and mirrors, it is also possible for further mechanical parts that are temperature-sensitive to be provided with a temperature control jacket 18′.

In addition to the deflecting mirrors 48 arranged in the projection objective 44, it is, of course, also possible for optical elements arranged in the EUV illumination system 42, such as mirrors and other mechanical parts, to be subjected to temperature control by means of a temperature control jacket 18′. This holds, for example, for aperture elements 49, as has been indicated schematically in the illumination system 42 in FIG. 7.

1-31. (canceled)

32. An apparatus for controlling the temperature of at least a part of a projection objective of the type used in semiconductor lithography, said apparatus comprising:
a temperature control jacket thermally coupleable to said at least a part of the projection objective, said temperature control jacket having at least one temperature control line having a passage for conducting flow of a fluid medium, said at least one temperature control line being integrally formed with said temperature control jacket.

33. An apparatus as claimed in claim 31, wherein said temperature control jacket includes a first subelement and a second subelement said temperature control line being formed of a void present in at least one of said first subelement and said second subelement.

34. An apparatus as claimed in claim 33, wherein said first subelement and said second subelement are joined in such a way that at least approximately full surface contact is present between said first subelement and said second subelement.

35. An apparatus as claimed in claim 33 or 34, wherein said first subelement and said second subelement are joined via an adhesive.

36. An apparatus as claimed in claim 33 or 34, wherein said first subelement and said second subelement are joined by soldering.

37. An apparatus as claimed in claim 36, wherein said first subelement and said second subelement are formed of aluminum.

38. An apparatus for controlling the temperature of at least one part of a projection objective of the type used in semiconductor lithography, said apparatus, comprising:
a temperature control jacket thermally coupleable to the at least one part of the projection objective, said temperature control jacket including at least a first subelement and a second subelement, said first subelement and said second subelement being joined to one another, said temperature control jacket having at least one temperature control line integrally formed in said temperature control jacket, said temperature control line having a passage for conducting flow of a fluid medium, at least a portion of said passage being formed of a void present in at least one of said first subelement and said second subelement.

39. The apparatus of claim 38, wherein said first subelement and said second subelement are joined to one another by way of an adhesive.

40. The apparatus of claim 38, wherein said first element and said second subelement are joined by way of a solder joint.

41. The apparatus of claim 40, wherein said solder joint is formed by applying solder in a cold state to at least one of said first subelement and said second subelement and subsequently applying heat to form said solder joint.

42. An apparatus for controlling the temperature of at least a part of a projection objective of the type used in semiconductor lithography, said apparatus comprising:
a temperature control jacket thermally coupleable to said at least a part of the projection objective, said temperature control jacket having at least one temperature control line having a passage for conducting flow of a fluid medium, said at least one temperature control line being integrally formed on said temperature control jacket via an electroplating process.

43. An apparatus as claimed in claim 42, wherein said temperature control line is formed by applying a mold to said temperature control jacket, coating said mold with an electrodeposited layer and removing said mold from said temperature control line after said electrodeposited layer has been deposited.

44. An apparatus as claimed in claim 43, wherein said mold comprises a structure formed of graphite-filled wax.

45. An apparatus as claimed in claim 43, wherein said mold comprises a structure formed of a metallically filled plastic.

46. A projection objective of the type used in semiconductor lithography for projecting an image of a reticle onto a wafer, said projection objective comprising:
a housing;
a plurality of optical elements disposed in an optical path for projecting the image of the reticle onto the wafer, and
a temperature control jacket thermally coupled to at least one of (i) at least a portion of said housing and (ii) at least one of said optical elements, said temperature control jacket comprising at least one electrodeposited layer which forms at least a portion of a temperature control line having a passage for carrying flow of a fluid medium.

47. A projection objective as claimed in claim 46, wherein at least a portion of said electrodeposited layer is electrodeposited onto a mold which is applied to said temperature control jacket prior to deposition of said electrodeposited layer and is removed from said temperature control jacket after deposition of said electrodeposited layer.

48. A projection objective as claimed in claim 47, wherein said mold comprises a structure formed of a filled material containing a filler selected from the group consisting of graphite and metal.

49. A projection objective as claimed in claim 42, wherein said mold comprises a structure formed of a material selected from the group consisting of a graphite-filled wax, and a metallically filled plastic.

50. An EUV projection exposure machine of the type used in semiconductor lithography for projecting an image of a reticle onto a wafer, said EUV projection exposure machine comprising:
an illumination system which includes an illumination source,
a housing, and
a projection objective disposed at least partially within said housing, said projection objective including a plurality of optical elements disposed in an optical path for projecting the image of the reticle onto said wafer using illumination from said illumination source, and
at least one temperature control jacket thermally coupled to at least one of (i) at least a portion of said housing, and (ii) at least one of said optical elements, said temperature control jacket comprising at least one electrodeposited layer which forms at least a portion of a temperature control line having a passage for carrying a fluid medium.

51. An EUV projection exposure machine as claimed in claim 50, wherein at least a portion of said electrodeposited layer is electrodeposited onto a mold compound which is applied to said temperature control jacket prior to deposition of said electrodeposited layer and is removed from said temperature control jacket after deposition of said electrodeposited layer.

52. An EUV projection exposure machine as claimed in claim 50 or 51, wherein said illumination system further includes a collector unit thermally coupled to at least one of said at least one temperature control jacket.

53. An EUV projection exposure machine as claimed in claim 50 or 51, wherein said plurality of optical elements includes at least one mirror thermally coupled to at least one of said at least one temperature control jackets.

54. An EUV projection exposure machine as claimed in claim 50 or 51, further comprising an aperture element thermally coupled to at least one of said at least one temperature control jackets.

55. An EUV projection exposure machine as claimed in claim 50 or 51, wherein said mold comprises a structure formed of a filled material containing a filler selected from the group consisting of a graphite-filled wax, and a metallically filled plastic.

56. An EUV projection exposure machine as claimed in claim 50 or 51, wherein said mold comprises a structure formed of a material selected from the group consisting of a graphite-filled wax, and a metallically filled plastic.

57. A method of making a device for controlling the temperature of at least a part of a projection objective of the type used in semiconductor lithography, said method comprising the steps of:
(a) providing a temperature control jacket thermally coupleable to said part of the projection objective, and
(b) forming, on at least a portion of said temperature control jacket, an electrodeposited layer which forms at least a portion of a temperature control line having an internal passage for carrying flow of a fluid medium.

58. A method according to claim 57, wherein said temperature control line is changeably formed.

59. A method according to claim 57, wherein said forming step comprises the steps of:
(a) applying a mold to said portion of said temperature control jacket, and
(b) electrodepositing material over said mold to form said electrodeposited layer.

60. A method according to claim 59, wherein said mold comprises a bead of electrically conductive material.

61. A method according to claim 59, wherein said material is a mold compound which includes an electrically conductive filler.

62. A method according to claim 61, wherein said filler comprises a filler material selected from the group consisting of graphite and a metal.

63. A method according to claim 59, wherein said molding compound comprises graphite-filled wax.

64. A method according to claim 59, wherein said molding compound comprises a metallically filled plastic.

65. A method according to claim 60, wherein said bead has a cross-sectional shape corresponding to a cross-section of said passage.

66. A method according to claim 59, further comprising the step of removing said mold material from said temperature control jacket after said electrodeposited layer has been formed.

67. A method according to claim 66, wherein said removing step comprises at least one of the following steps:
(a) heating said molding compound;
(b) washing away said molding compound; and
(c) etching away said molding compound.

68. A method according to claim 59, wherein said molding compound is applied to said temperature control jacket using a thermally unstable adhesive.
